(19) United States
(12) Patent Application Publication
(10) Pub. No.: US 2015/0302564 A1
(43) Pub. Date: Oct. 22, 2015

(54) METHOD FOR MAKING UP A SKIN TONE OF A HUMAN BODY IN AN IMAGE, DEVICE FOR MAKING UP A SKIN TONE OF A HUMAN BODY IN AN IMAGE, METHOD FOR ADJUSTING A SKIN TONE LUMINANCE OF A HUMAN BODY IN AN IMAGE, AND DEVICE FOR ADJUSTING A SKIN TONE LUMINANCE OF A HUMAN BODY IN AN IMAGE

(71) Applicant: Etron Technology, Inc., Hsinchu (TW)

(72) Inventors: Ming-Che Ho, Kaohsiung City (TW); Shin-Shiuan Cheng, Taipei City (TW); Yao-Nan Lee, Taipei City (TW); Yuan-Chang Chien, Taipei City (TW); Tian-Shiue Yen, New Taipei City (TW)

(21) Appl. No.: 14/608,157

(22) Filed: Jan. 28, 2015

(30) Foreign Application Priority Data
Apr. 16, 2014 (TW) 103113919

(51) Int. Cl. G06T 5/00; G06T 5/50; G06T 5/20

(52) U.S. Cl. CPC G06T 5/009; G06T 5/20; G06T 5/50; G06T 2207/10024; G06T 2207/20076; G06T 2207/20216; G06T 2207/20208; G06T 2207/30196; G06T 2207/30201; G06T 2207/20024

(57) ABSTRACT

A method for adjusting a skin tone luminance of a human body in an image including a first receiving unit receiving Y values of the image and a second receiving unit receiving Cb values and Cr values of the image; a filter module generating two different luminance values corresponding to each pixel of the image according to the Y values of the image; a skin tone probability unit generating a probability value of each pixel of the image corresponding to a skin tone of the human body according to the Cb values and the Cr values of the image; and a first mixing unit generating a skin tone luminance adjustment value corresponding to each pixel of the image according to two different luminance values corresponding to each pixel of the image and a probability value of each pixel of the image corresponding to the skin tone of the human body.

### BACKGROUND OF THE INVENTION

1. Field of the Invention

The present invention relates to a method for making up a skin tone of a human body in an image and a related device thereof, and a method for adjusting a skin tone luminance of a human body in an image and a related device thereof, and particularly to a method and a related device thereof that can utilize a Trapezoid model to make up a skin tone of a human body in an image and a method and a related device thereof that can utilize a Trapezoid model to adjust a skin tone luminance of a human body in an image.

2. Description of the Prior Art

When the prior art executes color correction on an image, the prior art will execute the color correction on all pixels corresponding to the image. Therefore, when the image includes a human face and the prior art executes the color correction on the image, the prior art will inevitably influence a skin tone of the human face, resulting in the skin tone of the human face being distorted. In addition, when the prior art executes luminance adjustment on the image, the prior art will execute the luminance adjustment on whole color space corresponding to the image. Therefore, when the image includes the human face and the prior art executes the luminance adjustment on the image, the prior art will inevitably influence luminance of the human face, resulting in the luminance of the human face being too bright or too dark. Therefore, the prior art is not a good choice for a user.

### SUMMARY OF THE INVENTION

An embodiment provides a method for making up a skin tone of a human body in an image, wherein a device applied to the method includes a first receiving unit, a second receiving unit, a filter module, a skin tone probability unit, a first mixing unit, a saturation adjustment unit, and a second mixing unit. The method includes the first receiving unit receiving Y values of the image and the second receiving unit receiving Cb values and Cr values of the image; the filter module generating two different luminance values corresponding to each pixel of the image according to the Y values of the image; the skin tone probability unit generating a probability value of each pixel of the image corresponding to a skin tone of the human body according to the Cb values and the Cr values of the image; the first mixing unit generating a skin tone luminance adjustment value corresponding to each pixel of the image according to two different luminance values corresponding to each pixel of the image and a probability value of each pixel of the image corresponding to the skin tone of the human body; the saturation adjustment unit generating a Cb adjustment value and a Cr adjustment value corresponding to each pixel of the image according to the Cb values and the Cr values of the image, respectively; and the second mixing unit generating a make-up human body skin tone image according to a skin tone luminance adjustment value corresponding to each pixel of the image, a Cb adjustment value corresponding to each pixel of the image, and a Cr adjustment value corresponding to each pixel of the image.

Another embodiment provides a method for adjusting a skin tone luminance of a human body in an image, wherein a device applied to the method includes a first receiving unit, a filter module, a skin tone probability unit, and a first mixing unit. The method including the first receiving unit receiving Y values of the image and the second receiving unit receiving Cb values and Cr values of the image; the filter module generating two different luminance values corresponding to each pixel of the image according to the Y values of the image; the skin tone probability unit generating a probability value of each pixel of the image corresponding to a skin tone of the human body according to the Cb values and the Cr values of the image; and the first mixing unit generating a skin tone luminance adjustment value corresponding to each pixel of the image according to two different luminance values corresponding to each pixel of the image and a probability value of each pixel of the image corresponding to the skin tone of the human body.

Another embodiment provides a device for making up a skin tone of a human body in an image. The device includes a first receiving unit, a second receiving unit, a filter module, a skin tone probability unit, a first mixing unit, a saturation adjustment unit, and a second mixing unit. The first receiving unit receives Y values of the image. The second receiving unit receives Cb values and Cr values of the image. The filter module is coupled to the first receiving unit for generating two different luminance values corresponding to each pixel of the image according to the Y values of the image. The skin tone probability unit is coupled to the second receiving unit for generating a probability value of each pixel of the image corresponding to a skin tone of the human body according to the Cb values and the Cr values of the image. The first mixing unit is coupled to the filter module and the skin tone probability unit for generating a skin tone luminance adjustment value corresponding to each pixel of the image according to two different luminance values corresponding to each pixel of the image and a probability value of each pixel of the image corresponding to the skin tone of the human body. The saturation adjustment unit is coupled to the second receiving unit for generating a Cb adjustment value and a Cr adjustment value corresponding to each pixel of the image according to the Cb values and the Cr values of the image, respectively. The second mixing unit is coupled to the first mixing unit and the saturation adjustment unit for generating a make-up human body skin tone image according to a skin tone luminance adjustment value corresponding to each pixel of the image, a Cb adjustment value corresponding to each pixel of the image, and a Cr adjustment value corresponding to each pixel of the image.

Another embodiment provides a device for adjusting a skin tone luminance of a human body in an image. The device includes a first receiving unit, a second receiving unit, a filter module, a skin tone probability unit, and a first mixing unit. The first receiving unit receives Y values of the image. The second receiving unit receives Cb values and Cr values of the image. The filter module is coupled to the first receiving unit for generating two different luminance values corresponding to each pixel of the image according to the Y values of the image. The skin tone probability unit is coupled to the second receiving unit for generating a probability value of each pixel of the image corresponding to a skin tone of the human body according to the Cb values and the Cr values of the image. The first mixing unit is coupled to the filter module and the skin tone probability unit for generating a skin tone luminance adjustment value corresponding to each pixel of the image according to two different luminance values corresponding to each pixel of the image and a probability value of each pixel of the image corresponding to the skin tone of the human body.

Another embodiment provides a method for making up a skin tone of a human body in an image, wherein a device applied to the method includes a first receiving unit, a second receiving unit, a filter module, a skin tone probability unit, a first mixing unit, a saturation adjustment unit, and a second mixing unit. The method includes the first receiving unit receiving Y values of the image and the second receiving unit receiving Cb values and Cr values of the image; the filter module generating two different luminance values corresponding to each pixel of the image according to the Y values of the image; the skin tone probability unit generating a probability value of each pixel of the image corresponding to a skin tone of the human body according to the Cb values, the Cr values of the image, and a Gaussian model corresponding to the skin tone of the human body; the first mixing unit generating a skin tone luminance adjustment value corresponding to each pixel of the image according to two different luminance values corresponding to each pixel of the image and a probability value of each pixel of the image corresponding to the skin tone of the human body; the saturation adjustment unit generating a Cb adjustment value and a Cr adjustment value corresponding to each pixel of the image according to the Cb values and the Cr values of the image, respectively; and the second mixing unit generating a make-up human body skin tone image according to a skin tone luminance adjustment value corresponding to each pixel of the image, a Cb adjustment value corresponding to each pixel of the image, and a Cr adjustment value corresponding to each pixel of the image.

Another embodiment provides a method for adjusting a skin tone luminance of a human body in an image, wherein a device applied to the method includes a first receiving unit, a filter module, a skin tone probability unit, and a first mixing unit. The method includes the first receiving unit receiving Y values of the image and the second receiving unit receiving Cb values and Cr values of the image; the filter module generating two different luminance values corresponding to each pixel of the image according to the Y values of the image; the skin tone probability unit generating a probability value of each pixel of the image corresponding to a skin tone of the human body according to the Cb values, the Cr values of the image, and a Gaussian model corresponding to a skin tone of the human body; and the first mixing unit generating a skin tone luminance adjustment value corresponding to each pixel of the image according to two different luminance values corresponding to each pixel of the image and a probability value of each pixel of the image corresponding to the skin tone of the human body.

Another embodiment provides a device for making up a skin tone of a human body in an image. The device includes a first receiving unit, a second receiving unit, a filter module, a skin tone probability unit, a first mixing unit, a saturation adjustment unit, and a second mixing unit. The first receiving unit receives Y values of the image. The second receiving unit receives Cb values and Cr values of the image. The filter module is coupled to the first receiving unit for generating two different luminance values corresponding to each pixel of the image according to the Y values of the image. The skin tone probability unit is coupled to the second receiving unit for generating a probability value of each pixel of the image corresponding to a skin tone of the human body according to the Cb values, the Cr values of the image, and a Gaussian model corresponding to the skin tone of the human body. The first mixing unit is coupled to the filter module and the skin tone probability unit for generating a skin tone luminance adjustment value corresponding to each pixel of the image according to two different luminance values corresponding to each pixel of the image and a probability value of each pixel of the image corresponding to the skin tone of the human body. The saturation adjustment unit is coupled to the second receiving unit for generating a Cb adjustment value and a Cr adjustment value corresponding to each pixel of the image according to the Cb values and the Cr values of the image, respectively. The second mixing unit is coupled to the first mixing unit and the saturation adjustment unit for generating a make-up human body skin tone image according to a skin tone luminance adjustment value corresponding to each pixel of the image, a Cb adjustment value corresponding to each pixel of the image, and a Cr adjustment value corresponding to each pixel of the image.

Another embodiment provides a device for adjusting a skin tone luminance of a human body in an image. The device includes a first receiving unit, a second receiving unit, a filter module, a skin tone probability unit, and a first mixing unit. The first receiving unit receives Y values of the image. The second receiving unit receives Cb values and Cr values of the image. The filter module is coupled to the first receiving unit for generating two different luminance values corresponding to each pixel of the image according to the Y values of the image. The skin tone probability unit is coupled to the second receiving unit for generating a probability value of each pixel of the image corresponding to a skin tone of the human body according to the Cb values, the Cr values of the image, and a Gaussian model corresponding to the skin tone of the human body. The first mixing unit is coupled to the filter module and the skin tone probability unit for generating a skin tone luminance adjustment value corresponding to each pixel of the image according to two different luminance values corresponding to each pixel of the image and a probability value of each pixel of the image corresponding to the skin tone of the human body.

The present invention provides a method for making up a skin tone of a human body in an image, a device for making up a skin tone of a human body in an image, a method for adjusting a skin tone luminance of a human body in an image, and a device for adjusting a skin tone luminance of a human body in an image. The method for making up a skin tone of a human body in an image, the device for making up a skin tone of a human body in an image, the method for adjusting a skin tone luminance of a human body in an image, and the device for adjusting a skin tone luminance of a human body in an image utilize a filter module and a skin tone probability unit to make up a skin tone of a human body in an image or to adjust a skin tone luminance of the human body in the image. Therefore, compared to the prior art, the present invention not only can soften the skin tone of the human body in the image, but can also ensure that the skin tone of the human body in the image is not distorted after adjusted. In addition, because the present invention only adjusts the skin tone of the human body in the image (however, the prior art executes luminance adjustment on whole color space corresponding to an image), the present invention does not make the skin tone luminance of the human body in the image too bright or too dark, and also not have a disadvantage corresponding to color shift. In addition, compared to the prior art, because the skin tone probability unit utilizes a linear trapezoidal model or a linear triangular model to approximate a Gaussian distribution, the present invention can significantly reduce operation burden of the skin tone probability unit and increase practicability of hardware calculation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating device for making up a skin tone of a human body in an image according to an embodiment.

FIG. 2 is a diagram illustrating the first low pass filter generating a first luminance value corresponding to a pixel of the image.

FIG. 3 is a diagram illustrating utilizing a linear trapezoidal model to approximate a Gaussian distribution.

FIG. 4 is a diagram illustrating utilizing a linear triangular model to approximate the Gaussian distribution.

FIG. 5 is a flowchart illustrating a method for making up a skin tone of a human body in an image according to another embodiment.

FIG. 6 is a flowchart illustrating a method for adjusting a skin tone luminance of a human body in an image according to another embodiment.

### DETAILED DESCRIPTION

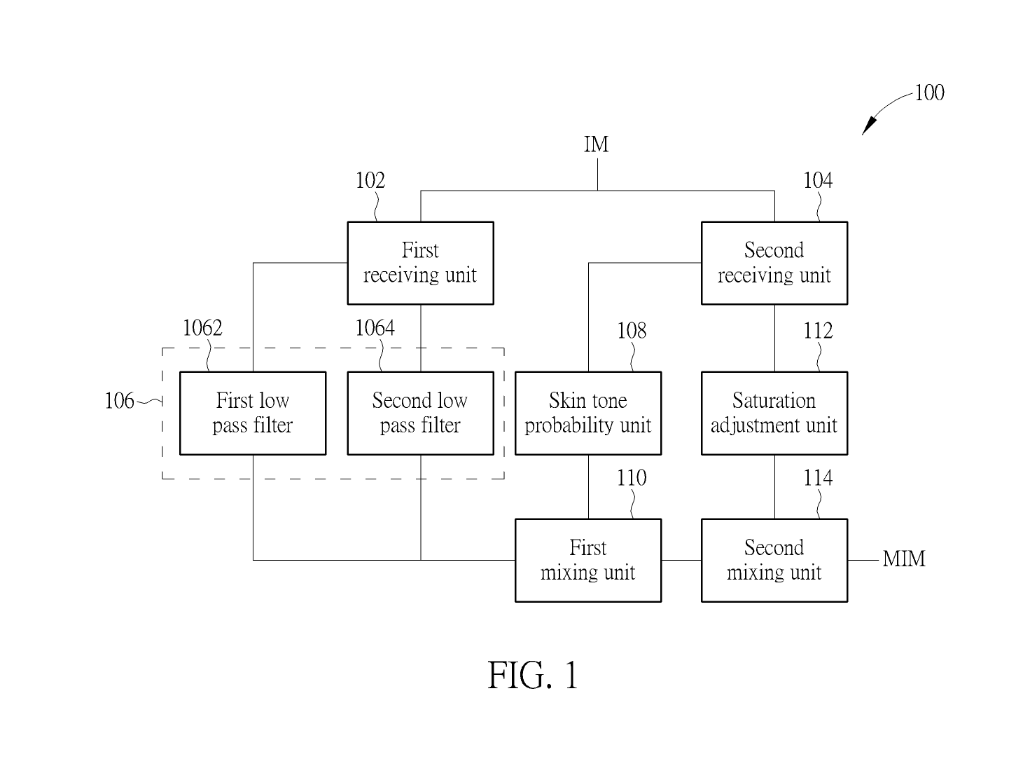

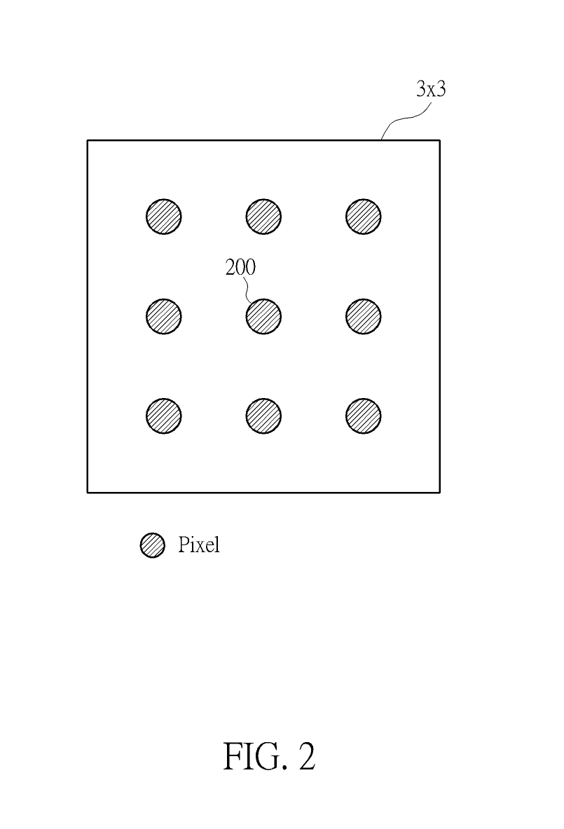

Please refer to FIG. 1. FIG. 1 is a diagram illustrating device 100 for making up a skin tone of a human body in an image according to an embodiment. As shown in FIG. 1, the device 100 includes a first receiving unit 102, a second receiving unit 104, a filter module 106, a skin tone probability unit 108, a first mixing unit 110, a saturation adjustment unit 112, and a second mixing unit 114, wherein the filter module 106 includes a first low pass filter 1062 and a second low pass filter 1064, wherein the first low pass filter 1062 and the second low pass filter 1064 can be bilateral filters, mean filters, median filter, or other low pass filters. As shown in FIG. 1, the first receiving unit 102 receives Y values of an image IM and the second receiving unit 104 receives Cb values and Cr values of the image IM. But, the present invention is not limited to the image IM being a YCbCr image. That is to say, the image IM can also be a YUV image or an RGB image. When the image IM is a YUV image, the first receiving unit 102 receives Y values of the image IM and the second receiving unit 104 receives U values and V values of the image IM; and when the image IM is an RGB image, the image IM needs to be converted into a YCbCr image or a YUV image. After the first receiving unit 102 receives the Y values of the image IM, the first low pass filter 1062 generates a first luminance value corresponding to each pixel of the image IM according to the Y values of the image IM, and the second low pass filter 1064 generates a second luminance value corresponding to each pixel of the image IM according to the Y values of the image IM, wherein a size of a first kernel (convolution mask) corresponding to the first low pass filter 1062 is less than a size of a second kernel corresponding to the second low pass filter 1064. For example, the size of the first kernel corresponding to the first low pass filter 1062 is 3*3 and the size of the second kernel corresponding to the second low pass filter 1064 is 7*7. But, the present invention is not limited to the size of the first kernel corresponding to the first low pass filter 1062 being 3*3 and the size of the second kernel corresponding to the second low pass filter 1064 being 7*7. Please refer to FIG. 2. FIG. 2 is a diagram illustrating the first low pass filter 1062 generating a first luminance value I_{Y}_{_{—}}_{F}(x) ₂₀₀ corresponding to a pixel 200 of the image IM. As shown in FIG. 2, because the first kernel (3*3) of the first low pass filter 1062 (e.g. a mean filter) corresponding to the pixel 200 includes 9 pixels (including the pixel 200 locating on a center of the first kernel (3*3) of the first low pass filter 1062), the first low pass filter 1062 can generate the first luminance value I_{Y}_{_{—}}_{F}(X)₂₀₀ corresponding to the pixel 200 according to luminances of the 9 pixels included in the first kernel (3*3) of the first low pass filter 1062 corresponding to the pixel 200. For example, the first luminance value I_{Y}_{_{—}}_{F}(X)₂₀₀ corresponding to the pixel 200 can be an average of the luminances of the 9 pixels included in the first kernel (3*3) of the first low pass filter 1062 corresponding to the pixel 200. In addition, the present invention is not limited to the first kernel (3*3) of the first low pass filter 1062 corresponding to the pixel 200 including 9 pixels. In addition, subsequent operational principles of the second low pass filter 1064 generating a second luminance value corresponding to each pixel of the image IM according to the Y values of the image IM are the same as those of the first low pass filter 1062 generating a first luminance value corresponding to each pixel of the image IM according to the Y values of the image IM, so further description thereof is omitted for simplicity.

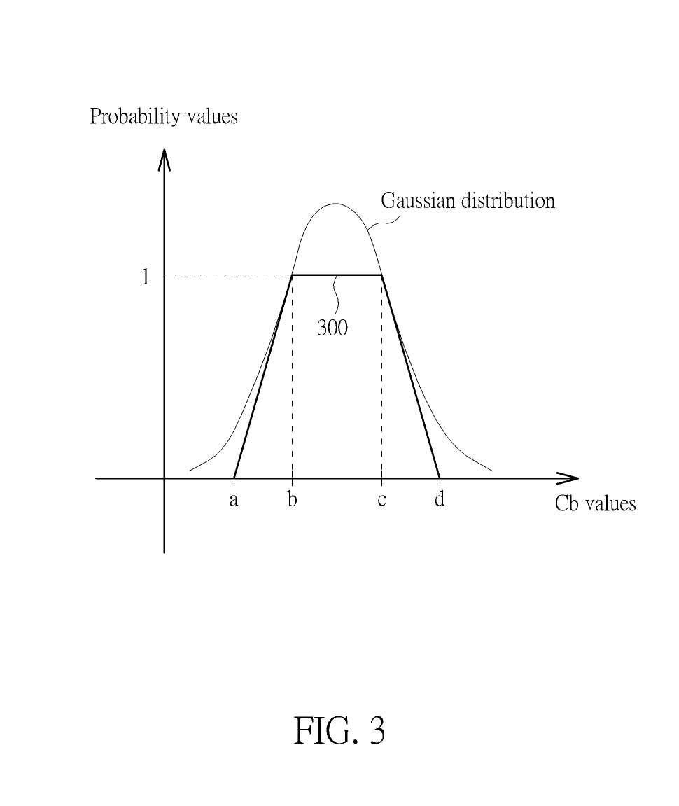

Please refer to FIG. 3. FIG. 3 is a diagram illustrating utilizing a linear trapezoidal model 300 to approximate a Gaussian distribution, wherein a vertical axis of FIG. 3 represents probability values and a horizontal axis of FIG. 3 represents the Cb values corresponding to the image IM. As shown in FIG. 3, the linear trapezoidal model 300 has vertexes a, b, c, d, wherein the vertexes a, b, c, d of the linear trapezoidal model 300 are generated according to a mean and a covariance of the Gaussian distribution, the vertexes a, b, c, d of the linear trapezoidal model 300 correspond to different Cb values of the image IM, and equation (1) can be used for defining the linear trapezoidal model 300. In addition, the Cr values of the image IM correspond to another linear trapezoidal model approximating FIG. 3. Therefore, the linear trapezoidal model 300 corresponding to the Cb values of the image IM and another linear trapezoidal model corresponding to the Cr values of the image IM can form a two-dimensional trapezoid model. Therefore, the skin tone probability unit 108 can generate a probability value of each pixel of the image IM corresponding to the skin tone of the human body according to the two-dimensional trapezoid model, and the Cb values and the Cr values of the image IM. That is to say, the skin tone probability unit 108 can generate a skin tone probability map corresponding to the image IM according to the two-dimensional trapezoid model, and the Cb values and the Cr values of the image IM.

$$p ( {I}_{Cb} ( x ) \vert a , b , c , d ) = \{ \begin{matrix}0 , & x 〈 a , x 〉 d \\ \frac{x - a}{b - a} , & a \leq x < b \\ 1 , & b \leq x < c \\ \frac{d - x}{d - c} , & c \leq x < d\end{matrix} \qquad ( 1 )$$

As shown in equation (1), I_{Cb}(x) is a Cb value corresponding to a pixel x. Therefore, substituting the Cb value corresponding to the pixel x into equation (1) can obtain a first skin tone probability value corresponding to the Cb value of the pixel x. Similarly, a second skin tone probability value corresponding to a Cr value of the pixel x can also be generated according to the above mentioned principles. Therefore, the skin tone probability unit 108 can utilize the two-dimensional trapezoid model to multiple the first skin tone probability value corresponding to the Cb value of the pixel x by the second skin tone probability value corresponding to the Cr value of the pixel x to generate a probability value of the pixel x corresponding to the skin tone of the human body.

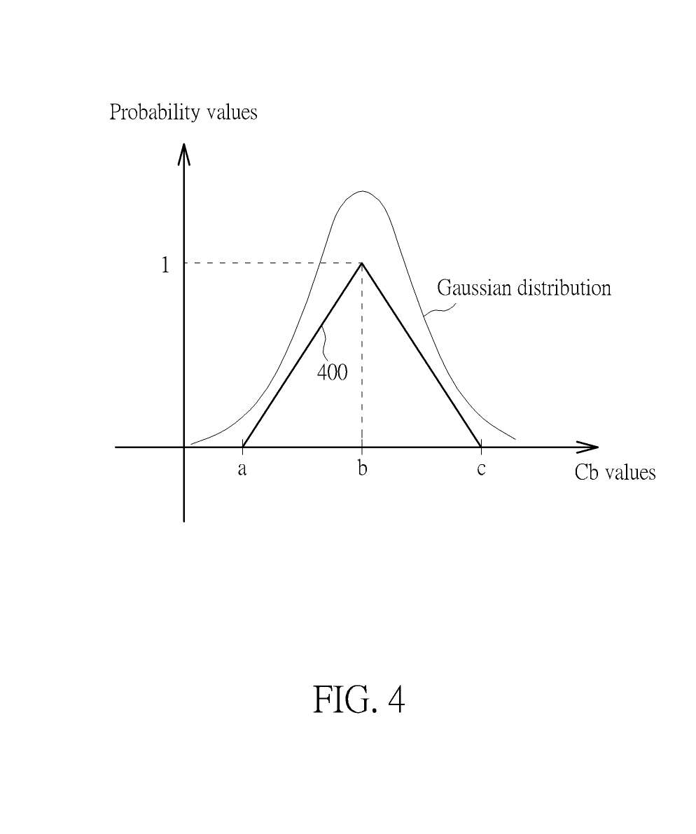

In addition, please refer to FIG. 4. FIG. 4 is a diagram illustrating utilizing a linear triangular model 400 to approximate the Gaussian distribution, wherein a vertical axis of FIG. 4 represents probability values and a horizontal axis of FIG. 4 represents the Cb values corresponding to the image IM. As shown in FIG. 4, the linear triangular model 400 has vertexes a, b, c, wherein the vertexes a, b, c of the linear triangular model 400 are generated according to the mean and the covariance of the Gaussian distribution, the vertexes a, b, c of the linear triangular model 400 correspond to different Cb values of the image IM, and equation (2) can be used for defining the linear triangular model 400. In addition, the Cr values of the image IM correspond to another linear triangular model approximating FIG. 4. Therefore, the linear triangular model 400 corresponding to the Cb values of the image IM and another linear triangular model corresponding to the Cr values of the image IM can also form a two-dimensional trapezoid model. Therefore, the skin tone probability unit 108 can generate a probability value of each pixel of the image IM corresponding to the skin tone of the human body according to the two-dimensional trapezoid model, and the Cb values and the Cr values of the image IM. That is to say, the skin tone probability unit 108 can generate the skin tone probability map corresponding to the image IM according to the two-dimensional trapezoid model, and the Cb values and the Cr values of the image IM.

$$p ( {I}_{Cb} ( x ) \vert a , b , c ) = \{ \begin{matrix}0 , & x 〈 a , x 〉 c \\ \frac{x - a}{b - a} , & a \leq x < b \\ \frac{b - x}{c - b} , & b \leq x < c\end{matrix} \qquad ( 2 )$$

In addition, in another of the present invention, the skin tone probability unit 108 can generate a probability value of each pixel of the image IM corresponding to the skin tone of the human body according to the Cb values and the Cr values of the image IM and a Gaussian model corresponding to the skin tone of the human body (that is, the Gaussian model corresponding to the skin tone of the human body has been built in the skin tone probability unit 108, so the skin tone probability unit 108 can directly generate a two-dimensional trapezoid model not through FIG. 3 or FIG. 4).

As shown in FIG. 1, after the filter module 106 generates a first luminance value and a second luminance value corresponding to each pixel of the image IM according to the Y values of the image IM, and the skin tone probability unit 108 generates a probability value of each pixel of the image IM corresponding to the skin tone of the human body according to the Cb values and the Cr values of the image IM, the first mixing unit 110 can generate a skin tone luminance adjustment value corresponding to each pixel of the image IM according to equation (3), a first luminance value and a second luminance value corresponding to each pixel of the image IM, and a probability value of each pixel of the image IM corresponding to the skin tone of the human body.

I′_{Y}(x)=(1−α)·I_{Y}_{_{—}}_{F}(x)+α·I_{Y}_{_{—}}_{S}(x)·L_{gain} (3)

As shown in equation (3), I′_{Y}(X) is a skin tone luminance adjustment value corresponding to the pixel x of the image IM, I_{Y}_{_{—}}_{F}(X) is a first luminance value corresponding to the pixel x of the image IM, I_{Y}_{_{—}}_{S}(x) ᵢs a second luminance value corresponding to the pixel x of the image IM, a is a probability value corresponding to the skin tone of the human body corresponding to the pixel x of the image IM, and L_{gain} is a luminance gain corresponding to the pixel x of the image IM.

As shown in FIG. 1, after the second receiving unit 104 receives the Cb values and the Cr values of the image IM, the saturation adjustment unit 112 generates a Cb adjustment value corresponding to each pixel of the image IM according to equation (4) and the Cb values of the image IM, and generates a Cr adjustment value corresponding to each pixel of the image IM according to equation (5) and the Cr value of the image IM.

I′_{Cb}(x)=S_{gain}(I_{Cb}(x)−128)+128 (4)

′_{Cr}(x)=S_{gain}(I_{Cr}(x)−128)+128 (5)

As shown in equation (4), _{ICb}(x) is a Cb value corresponding to the pixel x of the image IM, I_{Cb}(x) is a Cb adjustment value corresponding to the pixel x of the image IM, I_{Cr}(x) is a Cr value corresponding to the pixel x of the image IM, I′_{Cr}(x) is a Cr adjustment value corresponding to the pixel x of the image IM, and S_{gain} is a saturation gain corresponding to the pixel x of the image IM.

As shown in FIG. 1, after the first mixing unit 110 generates a skin tone luminance adjustment value corresponding to each pixel of the image IM according to a first luminance value and a second luminance value corresponding to each pixel of the image IM and a probability value of each pixel of the image IM corresponding to the skin tone of the human body, and the saturation adjustment unit 112 generates a Cb adjustment value and a Cr adjustment value corresponding to each pixel of the image IM according to the Cb values and the Cr values of the image IM respectively, the second mixing unit 114 can generate a make-up human body skin tone image MIM according to a skin tone luminance adjustment value corresponding to each pixel of the image IM, a Cb adjustment value corresponding to each pixel of the image IM, and a Cr adjustment value corresponding to each pixel of the image IM.

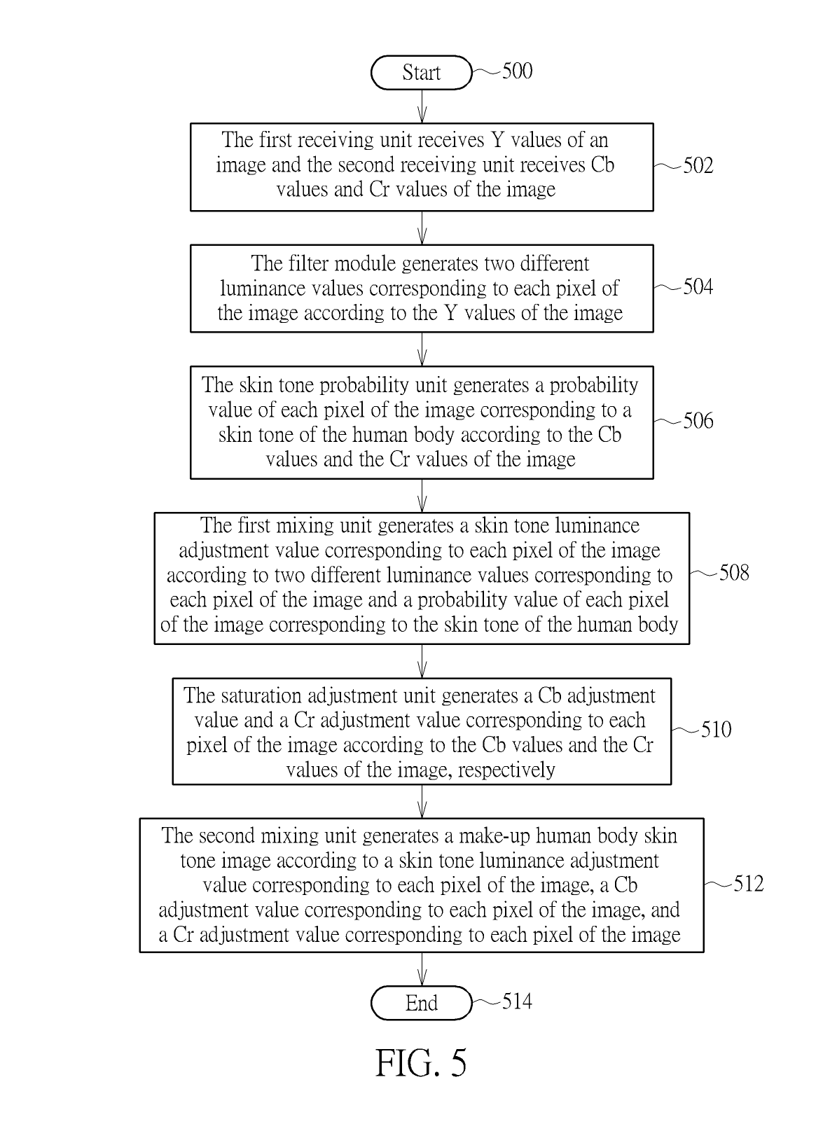

Please refer to FIG. 1 to FIG. 5. FIG. 5 is a flowchart illustrating a method for making up a skin tone of a human body in an image according to another embodiment. The method in FIG. 5 is illustrated using the device 100 in FIG. 1. Detailed steps are as follows:

Step 500: Start.

Step 502: The first receiving unit 102 receives Y values of an image IM and the second receiving unit 104 receives Cb values and Cr values of the image IM.

Step 504: The filter module 106 generates two different luminance values corresponding to each pixel of the image IM according to the Y values of the image IM.

Step 506: The skin tone probability unit 108 generates a probability value of each pixel of the image corresponding to a skin tone of the human body according to the Cb values and the Cr values of the image IM.

Step 508: The first mixing unit 110 generates a skin tone luminance adjustment value corresponding to each pixel of the image IM according to two different luminance values corresponding to each pixel of the image IM and a probability value of each pixel of the image IM corresponding to the skin tone of the human body.

Step 510: The saturation adjustment unit 112 generates a Cb adjustment value and a Cr adjustment value corresponding to each pixel of the image IM according to the Cb values and the Cr values of the image IM, respectively.

Step 512: The second mixing unit 114 generates a make-up human body skin tone image MIM according to a skin tone luminance adjustment value corresponding to each pixel of the image, a Cb adjustment value corresponding to each pixel of the image, and a Cr adjustment value corresponding to each pixel of the image IM.

Step 514: End.

In Step 502, as shown in FIG. 1, the first receiving unit 102 receives the Y values of the image IM and the second receiving unit 104 receives the Cb values and the Cr values of the image IM. But, the present invention is not limited to the image IM being a YCbCr image. That is to say, the image IM can also be a YUV image or an RGB image. When the image IM is a YUV image, the first receiving unit 102 receives Y values of the image IM and the second receiving unit 104 receives U values and V values of the image IM; and when the image IM is an RGB image, the image IM needs to be converted into a YCbCr image or a YUV image. In Step 504, as shown in FIG. 1, after the first receiving unit 102 receives the Y values of the image IM, the first low pass filter 1062 of the filter module 106 generates a first luminance value corresponding to each pixel of the image IM according to the Y values of the image IM, and the second low pass filter 1064 of the filter module 106 generates a second luminance value corresponding to each pixel of the image IM according to the Y values of the image IM. As shown in FIG. 2, because the first kernel (3*3) of the first low pass filter 1062 corresponding to the pixel 200 includes the 9 pixels (including the pixel 200 locating on the center of the first kernel (3*3) of the first low pass filter 1062), the first low pass filter 1062 can generate the first luminance value I_{Y}_{_{—}}_{F}(x)200 corresponding to the pixel 200 according to the luminances of the 9 pixels included in the first kernel (3*3) of the first low pass filter 1062 corresponding to the pixel 200. For example, the first luminance value I_{Y}_{_{—}}_{F}(x)₂₀₀ corresponding to the pixel 200 can be an average of the luminances of the 9 pixels included in the first kernel (3*3) of the first low pass filter 1062 corresponding to the pixel 200. In addition, the present invention is not limited to the first kernel of the first low pass filter 1062 corresponding to the pixel 200 including 9 pixels. In addition, subsequent operational principles of the second low pass filter 1064 generating a second luminance value corresponding to each pixel of the image IM according to the Y values of the image IM are the same as those of the first low pass filter 1062 generating a first luminance value corresponding to each pixel of the image IM according to the Y values of the image IM, so further description thereof is omitted for simplicity.

In Step 506, as shown in FIG. 3, the skin tone probability unit 108 can generate a probability value of each pixel of the image IM corresponding to the skin tone of the human body according to the two-dimensional trapezoid model and the Cb values and the Cr values of the image IM. That is to say, the skin tone probability unit 108 can generate a skin tone probability map corresponding to the image IM according to the two-dimensional trapezoid model and the Cb values and the Cr values of the image IM. In addition, in another of the present invention, the skin tone probability unit 108 can generate a probability value of each pixel of the image IM corresponding to the skin tone of the human body according to the Cb values and the Cr values of the image IM and the Gaussian model corresponding to the skin tone of the human body (that is, the Gaussian model corresponding to the skin tone of the human body has been built in the skin tone probability unit 108, so the skin tone probability unit 108 can directly generate a two-dimensional trapezoid model not through FIG. 3 or FIG. 4).

In Step 508, as shown in FIG. 1, after the filter module 106 generates a first luminance value and a second luminance value corresponding to each pixel of the image IM according to the Y values of the image IM, and the skin tone probability unit 108 generates a probability value of each pixel of the image IM corresponding to the skin tone of the human body according to the Cb values and the Cr values of the image IM, the first mixing unit 110 can generate a skin tone luminance adjustment value corresponding to each pixel of the image IM according to equation (3), a first luminance value and a second luminance value corresponding to each pixel of the image IM, and a probability value of each pixel of the image IM corresponding to the skin tone of the human body.

In Step 510, as shown in FIG. 1, after the second receiving unit 104 receives the Cb values and the Cr values of the image IM, the saturation adjustment unit 112 generates a Cb adjustment value corresponding to each pixel of the image IM according to equation (4) and the Cb values of the image IM, and generates a Cr adjustment value corresponding to each pixel of the image IM according to equation (5) and the Cr value of the image IM.

In Step 512, as shown in FIG. 1, after the first mixing unit 110 generates a skin tone luminance adjustment value corresponding to each pixel of the image IM according to a first luminance value and a second luminance value corresponding to each pixel of the image IM and a probability value of each pixel of the image IM corresponding to the skin tone of the human body, and the saturation adjustment unit 112 generates a Cb adjustment value and a Cr adjustment value corresponding to each pixel of the image IM according to the Cb values and the Cr values of the image IM respectively, the second mixing unit 114 can generate the make-up human body skin tone image MIM according to a skin tone luminance adjustment value corresponding to each pixel of the image IM, a Cb adjustment value corresponding to each pixel of the image IM, and a Cr adjustment value corresponding to each pixel of the image IM.

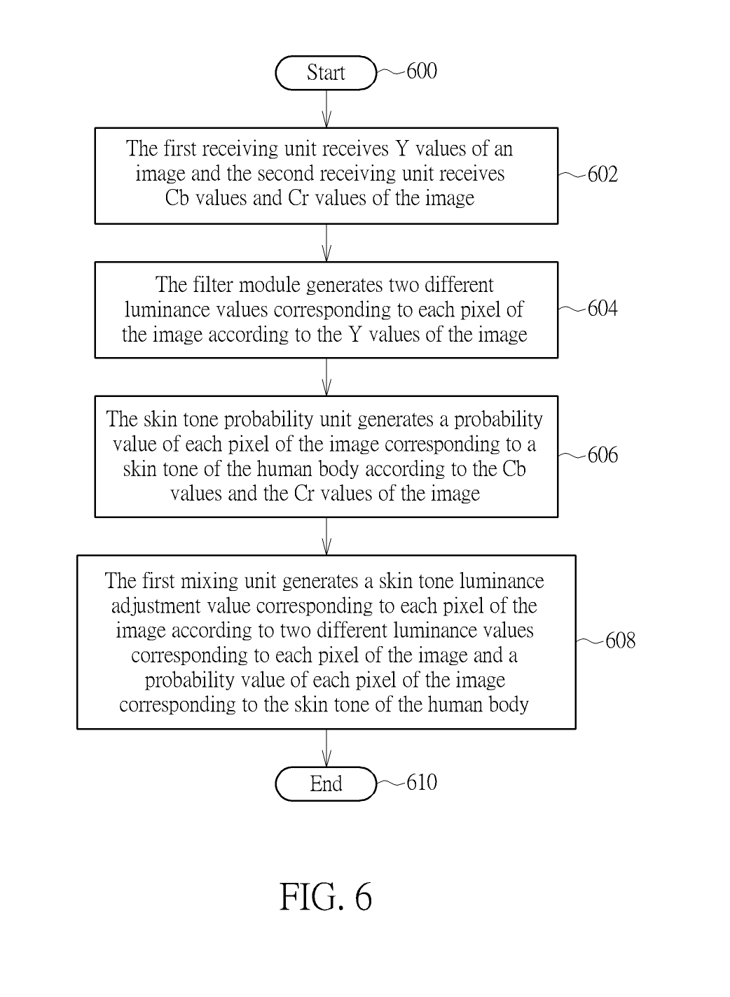

Please refer to FIG. 1 and FIG. 6. FIG. 6 is a flowchart illustrating a method for adjusting a skin tone luminance of a human body in an image according to another embodiment. The method in FIG. 6 is illustrated using the first receiving unit 102, the second receiving unit 104, the filter module 106, the skin tone probability unit 108, and the first mixing unit 110 of the device 100 shown in FIG. 1. Detailed steps are as follows:

Step 600: Start.

Step 602: The first receiving unit 102 receives Y values of an image IM and the second receiving unit 104 receives Cb values and Cr values of the image IM.

Step 604: The filter module 106 generates two different luminance values corresponding to each pixel of the image IM according to the Y values of the image IM.

Step 606: The skin tone probability unit 108 generates a probability value of each pixel of the image corresponding to a skin tone of the human body according to the Cb values and the Cr values of the image IM.

Step 608: The first mixing unit 110 generates a skin tone luminance adjustment value corresponding to each pixel of the image IM according to two different luminance values corresponding to each pixel of the image IM and a probability value of each pixel of the image IM corresponding to the skin tone of the human body.

Step 610: End.

Because operational principles of Steps 602-608 are the same as those of Steps 502-508, so further description thereof is omitted for simplicity.

To sum up, the method for making up a skin tone of a human body in an image, the device for making up a skin tone of a human body in an image, the method for adjusting a skin tone luminance of a human body in an image, and the device for adjusting a skin tone luminance of a human body in an image utilize the filter module and the skin tone probability unit to make up a skin tone of a human body in an image or to adjust a skin tone luminance of the human body in the image. Therefore, compared to the prior art, the present invention not only can soften the skin tone of the human body in the image, but can also ensure that the skin tone of the human body in the image is not distorted after adjusted. In addition, because the present invention only adjusts the skin tone of the human body in the image (however, the prior art executes luminance adjustment on whole color space corresponding to an image) , the present invention does not make the skin tone luminance of the human body in the image too bright or too dark, and also not have a disadvantage corresponding to color shift. In addition, compared to the prior art, because the skin tone probability unit utilizes a linear trapezoidal model or a linear triangular model to approximate a Gaussian distribution, the present invention can significantly reduce operation burden of the skin tone probability unit and increase practicability of hardware calculation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for making up a skin tone of a human body in an image, wherein a device applied to the method comprises a first receiving unit, a second receiving unit, a filter module, a skin tone probability unit, a first mixing unit, a saturation adjustment unit, and a second mixing unit, the method comprising:
the first receiving unit receiving Y values of the image and the second receiving unit receiving Cb values and Cr values of the image;
the filter module generating two different luminance values corresponding to each pixel of the image according to the Y values of the image;
the skin tone probability unit generating a probability value of each pixel of the image corresponding to a skin tone of the human body according to the Cb values and the Cr values of the image;
the first mixing unit generating a skin tone luminance adjustment value corresponding to each pixel of the image according to two different luminance values corresponding to each pixel of the image and a probability value of each pixel of the image corresponding to the skin tone of the human body;
the saturation adjustment unit generating a Cb adjustment value and a Cr adjustment value corresponding to each pixel of the image according to the Cb values and the Cr values of the image, respectively; and
the second mixing unit generating a make-up human body skin tone image according to a skin tone luminance adjustment value corresponding to each pixel of the image, a Cb adjustment value corresponding to each pixel of the image, and a Cr adjustment value corresponding to each pixel of the image.

2. The method of claim 1, wherein the filter module generating two different luminance values corresponding to each pixel of the image according to the Y values of the image comprises:
a first low pass filter of the filter module generating a first luminance value corresponding to each pixel of the image according to the Y values of the image, and a second low pass filter of the filter module generating a second luminance value corresponding to each pixel of the image according to the Y values of the image, wherein a size of a first kernel corresponding to the first low pass filter is less than a size of a second kernel corresponding to the second low pass filter.

3. The method of claim 2, wherein the first mixing unit generates a skin tone luminance adjustment value corresponding to each pixel of the image according to a following equation, and a first luminance value, a second luminance value, and a probability value corresponding to the skin tone of the human body corresponding to each pixel of the image:
I′_{y}(p)=(1−α)·I_{Y}_{_{—}}_{F} (p)+α·I_{Y}_{_{—}}_{S}(p)·L_{gain};
wherein:
I′_{Y}(p) is a skin tone luminance adjustment value corresponding to each pixel p of the image;
I_{Y}_{_{—}}_{F}(p) is a first luminance value corresponding to each pixel p of the image;
I_{Y}_{_{—}}_{S}(p) is a second luminance value corresponding to each pixel p of the image;
α is a ₚrobability value corresponding to the skin tone of the human body corresponding to each pixel p of the image; and
L_{gain} is a luminance gain corresponding to each pixel p of the image.

4. The method of claim 1, wherein the skin tone probability unit generating a probability value of each pixel of the image corresponding to the skin tone of the human body according to the Cb values and the Cr values of the image comprises:
the skin tone probability unit generating a probability value of each pixel of the image corresponding to the skin tone of the human body according to a two-dimensional Trapezoid model, and the Cb values and the Cr values of the image.

5. A method for adjusting a skin tone luminance of a human body in an image, wherein a device applied to the method comprises a first receiving unit, a second receiving unit, a filter module, a skin tone probability unit, and a first mixing unit, the method comprising:
the first receiving unit receiving Y values of the image and the second receiving unit receiving Cb values and Cr values of the image ;
the filter module generating two different luminance values corresponding to each pixel of the image according to the Y values of the image;
the skin tone probability unit generating a probability value of each pixel of the image corresponding to a skin tone of the human body according to the Cb values and the Cr values of the image; and
the first mixing unit generating a skin tone luminance adjustment value corresponding to each pixel of the image according to two different luminance values corresponding to each pixel of the image and a probability value of each pixel of the image corresponding to the skin tone of the human body.

6. The method of claim 5, wherein the filter module generating two different luminance values corresponding to each pixel of the image according to the Y values of the image comprises:
a first low pass filter of the filter module generating a first luminance value corresponding to each pixel of the image according to the Y values of the image, and a second low pass filter of the filter module generating a second luminance value corresponding to each pixel of the image according to the Y values of the image, wherein a size of a first kernel corresponding to the first low pass filter is less than a size of a second kernel corresponding to the second low pass filter.

7. The method of claim 6, wherein the first mixing unit generates a skin tone luminance adjustment value corresponding to each pixel of the image according to a following equation, and a first luminance value, a second luminance value, and a probability value corresponding to the skin tone of the human body corresponding to each pixel of the image:
I′_{Y}(p)=(1−α)·I_{Y}_{_{—}}_{F}(p)+α·I_{Y}_{_{—}}_{S}(p)·L_{gain};
wherein:
I′_{Y}(p) is a skin tone luminance adjustment value corresponding to each pixel p of the image;
I_{Y}_{_{—}}_{F} (p) is a first luminance value corresponding to each pixel p of the image;
I_{Y}_{_{—}}_{S}(p) is a second luminance value corresponding to each pixel p of the image;
α is a probability value corresponding to the skin tone of the human body corresponding to each pixel p of the image; and
L_{gain} is a luminance gain corresponding to each pixel p of the image.

8. The method of claim 5, wherein the skin tone probability unit generating a probability value of each pixel of the image corresponding to the skin tone of the human body according to the Cb values and the Cr values of the image comprises:
the skin tone probability unit generating a probability value of each pixel of the image corresponding to the skin tone of the human body according to a two-dimensional Trapezoid model, and the Cb values and the Cr values of the image.

9. A device for making up a skin tone of a human body in an image the device comprising:
a first receiving unit receiving Y values of the image;
a second receiving unit receiving Cb values and Cr values of the image;
a filter module coupled to the first receiving unit for generating two different luminance values corresponding to each pixel of the image according to the Y values of the image;
a skin tone probability unit coupled to the second receiving unit for generating a probability value of each pixel of the image corresponding to a skin tone of the human body according to the Cb values and the Cr values of the image;
a first mixing unit coupled to the filter module and the skin tone probability unit for generating a skin tone luminance adjustment value corresponding to each pixel of the image according to two different luminance values corresponding to each pixel of the image and a probability value of each pixel of the image corresponding to the skin tone of the human body;
a saturation adjustment unit coupled to the second receiving unit for generating a Cb adjustment value and a Cr adjustment value corresponding to each pixel of the image according to the Cb values and the Cr values of the image, respectively; and
a second mixing unit coupled to the first mixing unit and the saturation adjustment unit for generating a make-up human body skin tone image according to a skin tone luminance adjustment value corresponding to each pixel of the image, a Cb adjustment value corresponding to each pixel of the image, and a Cr adjustment value corresponding to each pixel of the image.

10. The device of claim 9, wherein the filter module comprises a first low pass filter and a second low pass filter, wherein the first low pass filter generates a first luminance value corresponding to each pixel of the image according to the Y values of the image, the second low pass filter generates a second luminance value corresponding to each pixel of the image according to the Y values of the image, and a size of a first kernel corresponding to the first low pass filter is less than a size of a second kernel corresponding to the second low pass filter.

11. The device of claim 10, wherein the first mixing unit generates a skin tone luminance adjustment value corresponding to each pixel of the image according to a following equation, and a first luminance value, a second luminance value, and a probability value corresponding to the skin tone of the human body corresponding to each pixel of the image:
I′_{Y}(p)=(1−α)·I_{Y}_{_{—}}_{F}(p)+α·I_{Y}_{_{—}}_{S}(p)·L_{gain};
wherein:
I′_{Y}(p) is a skin tone luminance adjustment value corresponding to each pixel p of the image;
I_{Y}_{_{—}}_{F}(p) is a first luminance value corresponding to each pixel p of the image;
I_{Y}_{_{—}}_{S}(p) is a second luminance value corresponding to each pixel p of the image;
α is a probability value corresponding to the skin tone of the human body corresponding to each pixel p of the image; and
L_{gain} is a luminance gain corresponding to each pixel p of the image.

12. The device of claim 9, wherein the skin tone probability unit generates a probability value of each pixel of the image corresponding to the skin tone of the human body according to a two-dimensional Trapezoid model, and the Cb values and the Cr values of the image.

13. A device for adjusting a skin tone luminance of a human body in an image, the device comprising:
a first receiving unit receiving Y values of the image;
a second receiving unit receiving Cb values and Cr values of the image;
a filter module coupled to the first receiving unit for generating two different luminance values corresponding to each pixel of the image according to the Y values of the image;
a skin tone probability unit coupled to the second receiving unit for generating a probability value of each pixel of the image corresponding to a skin tone of the human body according to the Cb values and the Cr values of the image; and
a first mixing unit coupled to the filter module and the skin tone probability unit for generating a skin tone luminance adjustment value corresponding to each pixel of the image according to two different luminance values corresponding to each pixel of the image and a probability value of each pixel of the image corresponding to the skin tone of the human body.

14. The device of claim 13, wherein the filter module comprises a first low pass filter and a second low pass filter, wherein the first low pass filter generates a first luminance value corresponding to each pixel of the image according to the Y values of the image, the second low pass filter generates a second luminance value corresponding to each pixel of the image according to the Y values of the image, and a size of a first kernel corresponding to the first low pass filter is less than a size of a second kernel corresponding to the second low pass filter.

15. The device of claim 14, wherein the first mixing unit generates a skin tone luminance adjustment value corresponding to each pixel of the image according to a following equation, and a first luminance value, a second luminance value, and a probability value corresponding to the skin tone of the human body corresponding to each pixel of the image:
I′_{Y}(p)=(1−α)·I_{Y}_{_{—}}_{F}(p)+α·I_{Y}_{_{—}}_{S}(p)·L_{gain};
wherein:
I′_{Y}(p) is a skin tone luminance adjustment value corresponding to each pixel p of the image;
I_{Y}_{_{—}}_{F}(p) is a first luminance value corresponding to each pixel p of the image;
I_{Y}_{_{≦}}_{S}(p) is a second luminance value corresponding to each pixel p of the image;
α is a probability value corresponding to the skin tone of the human body corresponding to each pixel p of the image; and
L_{gain} is a luminance gain corresponding to each pixel p of the image.

16. The device of claim 13, wherein the skin tone probability unit generates a probability value of each pixel of the image corresponding to the skin tone of the human body according to a two-dimensional Trapezoid model, and the Cb values and the Cr values of the image.

17. A method for making up a skin tone of a human body in an image, wherein a device applied to the method comprises a first receiving unit, a second receiving unit, a filter module, a skin tone probability unit, a first mixing unit, a saturation adjustment unit, and a second mixing unit, the method comprising:
the first receiving unit receiving Y values of the image and the second receiving unit receiving Cb values and Cr values of the image;
the filter module generating two different luminance values corresponding to each pixel of the image according to the Y values of the image;
the skin tone probability unit generating a probability value of each pixel of the image corresponding to a skin tone of the human body according to the Cb values, the Cr values of the image, and a Gaussian model corresponding to the skin tone of the human body;
the first mixing unit generating a skin tone luminance adjustment value corresponding to each pixel of the image according to two different luminance values corresponding to each pixel of the image and a probability value of each pixel of the image corresponding to the skin tone of the human body;
the saturation adjustment unit generating a Cb adjustment value and a Cr adjustment value corresponding to each pixel of the image according to the Cb values and the Cr values of the image, respectively; and
the second mixing unit generating a make-up human body skin tone image according to a skin tone luminance adjustment value corresponding to each pixel of the image, a Cb adjustment value corresponding to each pixel of the image, and a Cr adjustment value corresponding to each pixel of the image.

18. A method for adjusting a skin tone luminance of a human body in an image, wherein a device applied to the method comprises a first receiving unit, a second receiving unit, a filter module, a skin tone probability unit, and a first mixing unit, the method comprising:
the first receiving unit receiving Y values of the image and the second receiving unit receiving Cb values and Cr values of the image;
the filter module generating two different luminance values corresponding to each pixel of the image according to the Y values of the image;
the skin tone probability unit generating a probability value of each pixel of the image corresponding to a skin tone of the human body according to the Cb values, the Cr values of the image, and a Gaussian model corresponding to a skin tone of the human body; and
the first mixing unit generating a skin tone luminance adjustment value corresponding to each pixel of the image according to two different luminance values corresponding to each pixel of the image and a probability value of each pixel of the image corresponding to the skin tone of the human body.

19. A device for making up a skin tone of a human body in an image, the device comprising:
a first receiving unit receiving Y values of the image;
a second receiving unit receiving Cb values and Cr values of the image;
a filter module coupled to the first receiving unit for generating two different luminance values corresponding to each pixel of the image according to the Y values of the image;
a skin tone probability unit coupled to the second receiving unit for generating a probability value of each pixel of the image corresponding to a skin tone of the human body according to the Cb values, the Cr values of the image, and a Gaussian model corresponding to the skin tone of the human body;
a first mixing unit coupled to the filter module and the skin tone probability unit for generating a skin tone luminance adjustment value corresponding to each pixel of the image according to two different luminance values corresponding to each pixel of the image and a probability value of each pixel of the image corresponding to the skin tone of the human body;
a saturation adjustment unit coupled to the second receiving unit for generating a Cb adjustment value and a Cr adjustment value corresponding to each pixel of the image according to the Cb values and the Cr values of the image, respectively; and
a second mixing unit coupled to the first mixing unit and the saturation adjustment unit for generating a make-up human body skin tone image according to a skin tone luminance adjustment value corresponding to each pixel of the image, a Cb adjustment value corresponding to each pixel of the image, and a Cr adjustment value corresponding to each pixel of the image.

20. A device for adjusting a skin tone luminance of a human body in an image, the device comprising:
a first receiving unit receiving Y values of the image;
a second receiving unit receiving Cb values and Cr values of the image;
a filter module coupled to the first receiving unit for generating two different luminance values corresponding to each pixel of the image according to the Y values of the image;
a skin tone probability unit coupled to the second receiving unit for generating a probability value of each pixel of the image corresponding to a skin tone of the human body according to the Cb values, the Cr values of the image, and a Gaussian model corresponding to the skin tone of the human body; and
a first mixing unit coupled to the filter module and the skin tone probability unit for generating a skin tone luminance adjustment value corresponding to each pixel of the image according to two different luminance values corresponding to each pixel of the image and a probability value of each pixel of the image corresponding to the skin tone of the human body.
